(19) United States
(12) Patent Application Publication
(10) Pub. No.: US 2025/0155789 A1
(43) Pub. Date: May 15, 2025

(54) IMAGE GENERATION UNIT AND PROJECTION TYPE IMAGE DISPLAY DEVICE

(71) Applicant: Panasonic Holdings Corporation, Osaka (JP)

(72) Inventor: Yuki Yamagata, Osaka (JP)

(21) Appl. No.: 19/020,543

(22) Filed: Jan. 14, 2025

Related U.S. Application Data
(63) Continuation of application No. PCT/JP2023/026390, filed on Jul. 19, 2023.

(30) Foreign Application Priority Data
Jul. 22, 2022 (JP) 2022-117458

(51) Int. Cl. G03B 33/12

(52) U.S. Cl. CPC G03B 33/12

(57) ABSTRACT

An image generation unit includes three light modulation elements including a first light modulation element, a second light modulation element, and a third light modulation element that modulate light based on an image signal to generate image light, and a color separator-combiner prism including a first prism, a second prism, and a third prism that are sequentially arranged along an optical axis and guide light to the three light modulation elements. The third prism has a bottom surface facing the third light modulation element and perpendicular to the optical axis, and a first side surface adjacent to the bottom surface, and a part of the image light from the first light modulation element is transmitted through the first dichroic surface between the first prism and the second prism as unnecessary light, transmitted through the second prism, and incident on the third prism.

### TECHNICAL FIELD

The present disclosure relates to an image generation unit and a projection type image display device including the image generation unit.

### BACKGROUND ART

In recent years, projection type image display devices (projectors) using digital micromirror devices (DMD) have been developed and are beginning to spread. In the digital micromirror device, in addition to ON light that becomes image light optically modulated based on an image signal OFF light that does not appear in the image signal and is not used as the image light is generated. For this reason, it is necessary to direct the OFF light in a direction different from that of the image light, and for example, a technology in which the OFF light from the DMD is not incident on the color separator-combiner prism is disclosed (see, for example, PTL 1).

### CITATION LIST

### Patent Literature

PTL 1: Unexamined Japanese Patent Publication No. 2015-81931

### SUMMARY OF THE INVENTION

The image light modulated by each image display element is guided from each prism to the projection unit. For example, as illustrated in FIG. 7, image light 2 from first light modulation element 51B is reflected by first dichroic surface 139 between a first prism and a second prism, and travels toward the projection unit along optical axis 8.

However, a part of image light 2 is transmitted through first dichroic surface 139 as unnecessary light 16, is transmitted through second prism 136, and is incident on third prism 137. Unnecessary light 16 may be reflected by the first side surface of third prism 137, further transmitted through the bottom surface of third prism 137, collided with third light modulation element 51G, absorbed, and generate heat. The case where a part of such image light is transmitted through prisms 134, 136, 137 as unnecessary light has not been assumed so far.

Therefore, an object of the present disclosure is to provide an image generation unit capable of suppressing heat generation due to unnecessary light even in a case where a part of image light becomes unnecessary light and is transmitted through a prism.

An image generation unit according to the present disclosure includes: three light modulation elements including a first light modulation element, a second light modulation element, and a third light modulation element that modulate light based on an image signal to generate image light, and a color separator-combiner prism including a first prism, a second prism, and a third prism that are sequentially arranged along an optical axis and guide light to the first light modulation element, the second light modulation element, and the third light modulation element, respectively. The third prism has a bottom surface facing the third light modulation element and perpendicular to the optical axis, and a first side surface adjacent to the bottom surface, and a part of the image light from the first light modulation element is transmitted through the first dichroic surface between the first prism and the second prism as unnecessary light, transmitted through the second prism, and incident on the third prism. The first side surface of the third prism is configured to reflect the unnecessary light incident on the third prism toward the bottom surface, and the bottom surface of the third prism is configured to totally reflect the unnecessary light reflected by the first side surface.

A projection video display device according to the present disclosure includes a light source unit that generates light, the image generation unit, a light guide optical system that guides the light from the light source unit to the image generation unit, and a projection optical system that projects the image light generated by the image generation unit.

According to the projection video display device using the image generation unit and the image generation unit of the present disclosure, even in a case where a part of the image light becomes unnecessary light and is transmitted through the prism, the unnecessary light does not reach the third light modulation element, and heat generation due to the unnecessary light can be suppressed.

### BRIEF DESCRIPTION OF THE DRAWINGS

FIG. 1 is a block diagram illustrating a configuration of a projection type image display device including an image generation unit according to a first exemplary embodiment.

FIG. 2 is a schematic view illustrating an optical system of a projection type image display device including an image generation unit in FIG. 1.

FIG. 3 is a schematic perspective view illustrating a TIR prism and a color separator-combiner prism in the projection type image display device according to the first exemplary embodiment.

FIG. 4 is a schematic view of the TIR prism and the color separator-combiner prism of FIG. 3 as viewed from the −Y direction.

FIG. 5 is a schematic view illustrating an optical path of unnecessary light in FIG. 4 in a third prism.

FIG. 6 is a schematic view of a TIR prism and a color separator-combiner prism as viewed from a +Z direction in a projection type image display device according to a reference example.

FIG. 7 is a schematic view of the TIR prism and the color separator-combiner prism of FIG. 6 as viewed from the −Y direction.

### DESCRIPTION OF EMBODIMENT

<Background to the present disclosure>

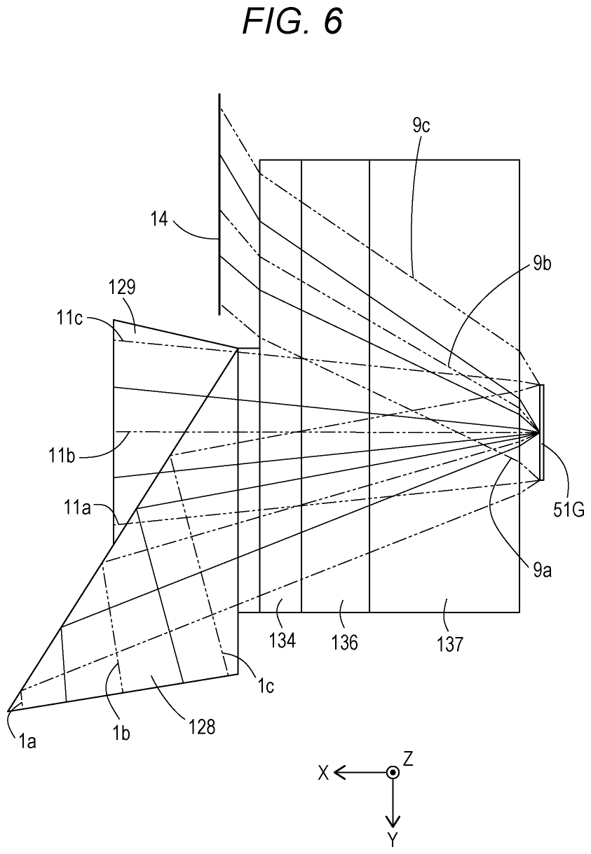

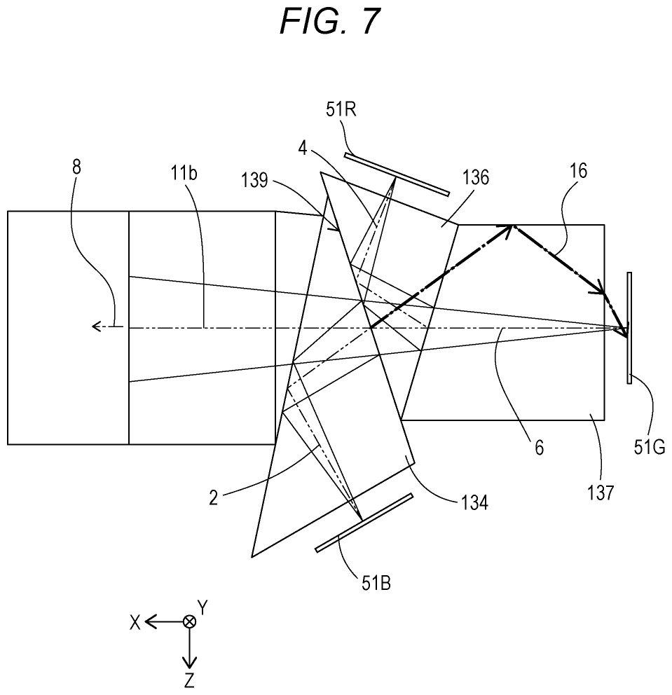

FIG. 6 is a schematic view of TIR prisms 128, 129 and color separator-combiner prism 61 (134, 136, 137) viewed from the +Z direction in the projection type image display device according to the reference example. FIG. 7 is a schematic view of TIR prisms 128, 129 and color separator-combiner prism 61 (134, 136, 137) of FIG. 6 as viewed from the −Y direction.

As described above, the case where a part of the image light is transmitted through prisms 134, 136, 137 as unnecessary light has not been assumed so far.

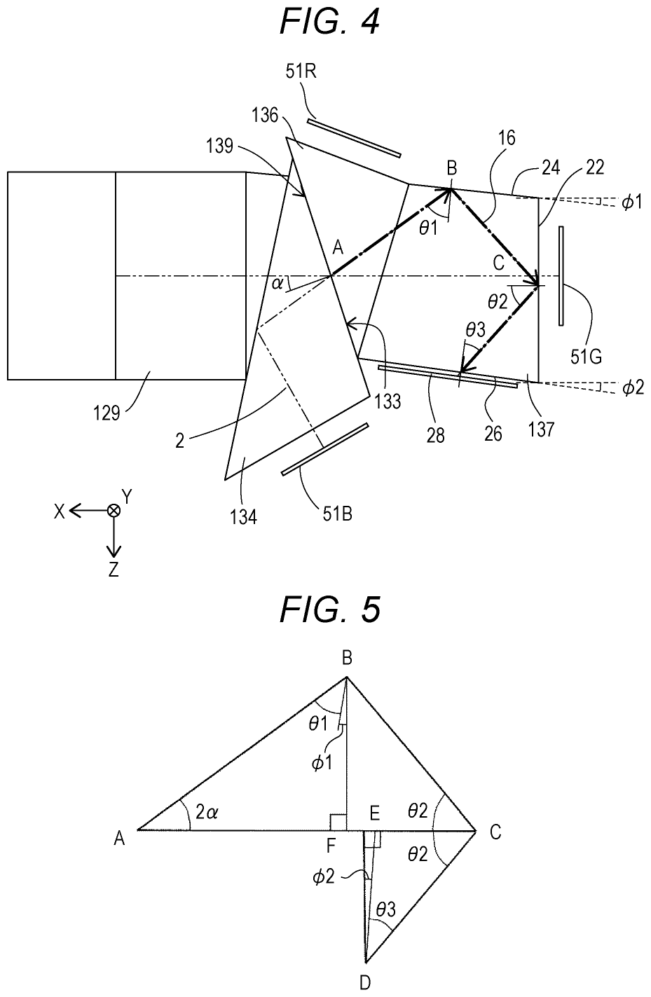

As a result of intensive studies, the present inventors have found that unnecessary light 16 reflected by first side surface 24 of third prism 137 is configured to be totally reflected by bottom surface 22 as illustrated in FIG. 4, so that it is possible to suppress that the unnecessary light strikes the third light modulation element, is absorbed, and generates heat, and this has led to the present disclosure.

An image generation unit according to a first aspect includes: three light modulation elements of a first light modulation element, a second light modulation element, and a third light modulation element that modulate light on the basis of an image signal to generate image light; and a color separator-combiner prism including a first prism, a second prism, and a third prism that are sequentially arranged from a light incident surface along a front side to a rear side of an optical axis and guide light to each of the three light modulation elements, in which the third prism faces the third light modulation element, has a bottom surface perpendicular to the optical axis and a side surface adjacent to the bottom surface, and a part of the image light from the first light modulation element is transmitted through a first dichroic surface between the first prism and the second prism as unnecessary light, is transmitted through the second prism, and is incident on the third prism, the first side surface of the third prism on which the unnecessary light is incident is configured to reflect the unnecessary light with respect to the bottom surface, and the bottom surface of the third prism is configured to totally reflect the unnecessary light reflected by the first side surface of the third prism.

In the image generation unit of a second aspect, in the first aspect, the first side surface of the third prism may be disposed at an angle of not 90 degrees with respect to the bottom surface.

In the second aspect, the image generation unit according to a third aspect may be disposed such that the first side surface forms an obtuse angle with respect to the bottom surface.

In any one of the first to third aspects, the image generation unit according to a fourth aspect may have the first side surface subjected to mirror processing.

In any one of the first to fourth aspects, the image generation unit according to a fifth aspect may satisfy the following Formulas 1 to 3 with respect to angle 2α formed with the optical axis of the unnecessary light, incident angle θ1 of the unnecessary light to the first side surface, incident angle θ2 of the unnecessary light to the bottom surface, angle φ1 formed by the first side surface with the normal line of the bottom surface, and critical angle θc of a sodium d-line in the third prism.

$$φ 1 > 0 \qquad ( Formula 1 )$$

$$θ1 = 90 ° - 2 α - φ1 > θ c \qquad ( Formula 2 )$$

$$θ2 = 2 α + 2 φ1 > θ c \qquad ( Formula 3 )$$

In the image generation unit according to a sixth aspect, in any one of the first to fifth aspects, a second side surface facing the first side surface of the third prism with the bottom surface interposed therebetween may be provided with an absorption plate that absorbs unnecessary light totally reflected by the bottom surface.

A projection type image display device according to a seventh aspect includes: a light source unit that generates light; a light guide optical system that guides light from the light source unit; the image generation unit according to any one of the first to sixth aspects that modulates the light guided from the light guide optical system based on an image signal to generate image light; and a projection optical system that projects the image light.

An image generation unit according to an exemplary embodiment and a projection type image display device will be described below with reference to the accompanying drawings. The drawings show substantially the same members that are designated by the same reference numerals.

### First Exemplary Embodiment

<Projection type image display device (Projector)>

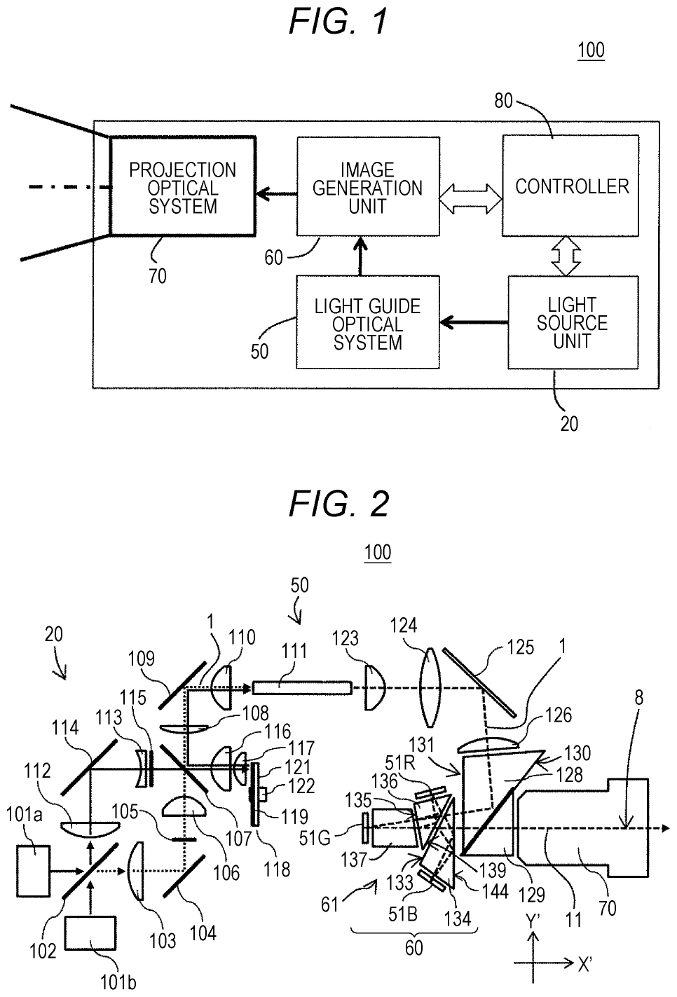

FIG. 1 is a block diagram illustrating a configuration of projection type image display device (projector) 100 including an image generation unit according to a first exemplary embodiment. FIG. 2 is a schematic view illustrating an optical system of the projection type image display device including the image generation unit in FIG. 1.

The projection type image display device according to the first exemplary embodiment includes light source unit 20, light guide optical system 50, image generation unit 60, projection optical system 70, and controller 80. Light guide optical system 50 is an optical system that guides light from light source unit 20 to image generation unit 60. Image generation unit 60 separates light into three primary colors of RGB by color separator-combiner prism 61, and modulates each of the RGB light with an image signal by a digital micromirror device (DMD) to generate image light. Projection optical system 70 projects the generated image light onto a screen or the like to form an image. Controller 80 controls light source unit 20, light guide optical system 50, image generation unit 60, and projection optical system 70 described above.

Each member constituting projection type image display device 100 will be described below.

<Light source unit>

Light source unit 20 mainly includes first light source unit 101a, second light source unit 101b, separating and combining mirror 102, and phosphor wheel 118. Light source unit 20 further includes lens groups 103, 106, 113, 116, 117 and mirror groups 104, 114.

For example, first light source unit 101a and second light source unit 101b may be configured with a plurality of solid-state light sources such as a laser diode (LD) or a light emitting diode (LED). In the first exemplary embodiment, among laser diodes, a laser diode that emits blue light is particularly used as the solid-state light source. Here, the laser diode is an example of a laser light source.

The light emitted from first light source unit 101a and second light source unit 101b is, for example, blue light having a wavelength of between 440 nm and 470 nm (inclusive). This blue light is also used as excitation light for exciting phosphor 119 of phosphor wheel 118.

<Phosphor Wheel>

Phosphor wheel 118 rotates about rotation shaft 122 extending along the optical axis of the excitation light. Phosphor wheel 118 is a reflection type phosphor wheel that emits fluorescence in a direction opposite to the incident direction of the excitation light. That is, phosphor wheel 118 includes substrate 121, phosphor 119 annularly applied and formed on substrate 121 along the rotation direction of substrate 121, and a motor (not illustrated) for rotating substrate 121 on which phosphor 119 is formed. A reflecting film for reflecting fluorescence light emitted from phosphor 119 is formed on the surface of substrate 121. Phosphor 119 emits fluorescence including yellow light according to excitation light emitted from first light source unit 101a and second light source unit 101b.

The excitation light is diffused by top-hat diffusion element 115 and condensed on phosphor 119 by lenses 116 and 117 to emit fluorescence.

The phosphor is an example of a light emitter, and is, for example, a phosphor that emits fluorescence in a main wavelength range from green to yellow. Phosphor 119 is preferably a phosphor that efficiently absorbs blue excitation light to efficiently emit fluorescence and has high resistance to temperature quenching. Phosphor 119 is, for example, Y₃A₁₅O₁₂:Ce₃₊which is a phosphor having a garnet structure activated by cerium.

From light source unit 20, light 1 including excitation light of blue light and fluorescence of yellow light is guided to light guide optical system 50.

<Light Guide Optical System>

Light guide optical system 50 is an optical system that guides light 1 from light source unit 20 to image generation unit 60. Light guide optical system 50 mainly includes rod integrator 111, lens groups 108, 110, 123, 124, and mirror groups 109, 125.

Rod integrator 111 is, for example, a solid rod made of a transparent member such as glass. Rod integrator 111 can make spatial intensity distributions of excitation light emitted from first light source unit 101a and second light source unit 101b and fluorescence from phosphor wheel 118 uniform. Note that, rod integrator 111 may be a hollow rod whose inner wall is formed of a mirror surface. Rod integrator 111 is a type of light uniformizing element.

<Image Generation Unit>

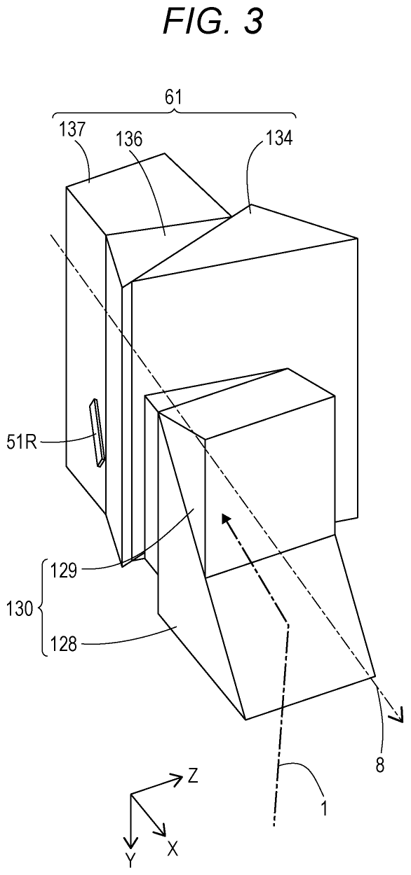

FIG. 3 is a schematic perspective view illustrating TIR prisms 128, 129 and color separator-combiner prism 61 (134, 136, 137) in the projection type image display device according to the first exemplary embodiment. FIG. 4 is a schematic view of TIR prisms 128, 129 and color separator-combiner prism 61 (134, 136, 137) of FIG. 3 as viewed from the −Y direction.

For convenience, in FIG. 3, the direction of optical axis 8 of the image light generated by each light modulation element (DMD) is indicated as a +X direction. In each drawing, the height direction of each prism (134, 136, 137) having a triangular prism shape of color separator-combiner prism 61 is represented as the −Y direction. A Z direction perpendicular to the X direction and the Y direction is also shown.

Image generation unit 60 includes TIR prisms 128, 129 that guide illumination light 1 from light guide optical system 50 to color separator-combiner prism 61, color separator-combiner prism 61 including three prisms of first prisms 134, second prism 136, and third prism 137 that separate and combine illumination light 1 into three primary colors of RGB, and first DMD (51B), second DMD (51R), and third DMD (51G) that are three digital micromirror devices (DMD) that generate image light by modulating based on image signals of the separated three primary colors of RGB.

Further, similarly to the reference example illustrated in FIG. 6, image generation unit 60 may include light shielding plate 14 that is provided on the front side of optical axis 8 of first prism 134 and absorbs a part of the OFF light generated by third modulation element 51G and transmitted through third prism 137, second prism 136, and first prism 134.

<Tir Prism>

TIR prisms 128, 129 guide illumination light 1 from light guide optical system 50 to color separator-combiner prism 61. TIR prism 128 is formed of a light-transmissive member, and has surface 130 facing TIR prism 129 and surface 131 facing first prism 134 of color separator-combiner prism 61. An air gap is provided between TIR prism 128 (FIG. 2: surface 130) and TIR prism 129, and the incident angle at which the light incident on TIR prism 128 is incident on surface 130 is larger than the critical angle, so that the light incident on TIR prism 128 is reflected by surface 130. On the other hand, an air gap is provided between TIR prism 128 (surface 131 in FIG. 2) and first prism 134 (surface 144 in FIG. 2), but the angle (incident angle) at which the light reflected by surface 130 is incident on surface 131 is smaller than the critical angle, so that the light reflected by surface 130 is transmitted through surface 131.

<Light Modulation Element: Digital Micromirror Device (DMD)>

Light modulation element 51G, 51R, 51B is, for example, a digital micromirror device (DMD). First DMD (51B), second DMD (51R), and third DMD (51G), which are digital micromirror devices, are configured by a plurality of movable micro mirrors, and each micro mirror corresponds to one pixel. In first DMD (51B), second DMD (51R), and third DMD (51G), by changing the angle of each micro mirror based on the image signal, whether light is reflected to the side of projection unit 70 side is switched to generate image light. First DMD (51B), second DMD (51R), and third DMD (51G) are one type of light modulation elements. Each of the three DMDs is configured to modulate light based on an image signal to generate image light.

Strictly speaking, the light guided to first DMD (51B) is first component light (blue component light) dispersed from light 1 guided from light guide optical system 50, and the light modulated by first DMD (51B) is first modulation light 2. Similarly, the light guided to second DMD (51R) is dispersed second component light (red component light), and the light modulated by second DMD (51R) is second modulation light 4. The light guided to third DMD (51G) is dispersed third component light (green component light), and the light modulated by third DMD (51G) is third modulation light 6.

In first DMD (51B), second DMD (51R), and third DMD (51G), as illustrated in FIGS. 4 and 8, first modulation light 2, second modulation light 4, and third modulation light 6, which are the ON light as the image light, are emitted, and OFF lights 9a, 9b, 9c, which are not the image light, are emitted while deviated from the optical axis (X direction). First modulation light 2, second modulation light 4, and third modulation light 6 respectively indicate image light emitted along widths of first DMD (51B), second DMD (51R), and third DMD (51G). Similarly, OFF light 9a, 9b, 9c indicates OFF light emitted along the width of third DMD (51G).

FIG. 7 illustrates only OFF light 9a, 9b, 9c from third DMD (51G) which is the third modulation element. In the drawing, OFF lights emitted from other first DMD (51B) and second DMD (51R) are omitted.

As illustrated in FIG. 7, OFF light 9a, 9b, 9c passes through third prism 137, second prism 136, and first prism 134, and is absorbed by light shielding plate 14. For example, OFF light 9a, 9b passes through third prism 137, second prism 136, and first prism 134 and is absorbed by light shielding plate 14, and OFF light 9c is absorbed by light shielding plate 14.

<Color Separator-Combiner Prism>

Color separator-combiner prism 61 is formed of a light-transmissive member, and includes first prism 134, second prism 136, and third prism 137 arranged in order along the direction of optical axis 8. Color separator-combiner prism 61 may be, for example, a dichroic prism-Phillips type. Surface 133 of first prism 134 is, for example, a dichroic mirror surface that transmits the red component light and the green component light and reflects the blue component light. Therefore, of light 1 reflected by surface 130 of TIR prism 128, the red component light and the green component light are transmitted through surface 133, and the blue component light is reflected by surface 133. The blue component light reflected by surface 133 is reflected by surface 144 and guided to first DMD (51G). Surface 135 of second prism 136 is a dichroic mirror surface that transmits the green component light and reflects the red component light. Therefore, of the light incident on second prism 136, the green component light is transmitted through surface 135, and the red component light is reflected by surface 135. The red component light reflected by surface 135 is guided to second DMD (51R). The green component light transmitted through surface 135 of second prism 136 and incident on third prism 137 is guided to third DMD (51B).

Note that the component light guided by first prism 134 and second prism 136 may be exchanged, the red component light may be guided to the first DMD by first prism 134, and the blue component light may be guided to the second DMD by second prism 136.

That is, the green component light, the red component light, and the blue component light are light dispersed by color separator-combiner prism 61.

As illustrated in FIG. 4, first prism 134 receives blue image light 2 that is the first modulation light modulated by first DMD (51B), and guides the blue image light to the optical path along optical axis 8. Similarly to the reference example, second prism 136 receives red image light 4 that is the second modulation light modulated by second DMD (51R), and guides the red image light to the optical path along optical axis 8. Third prism 137 receives green image light 6 that is the third modulation light modulated by third DMD (51G), and guides the green image light to the optical path along optical axis 8.

That is, blue image light 2, red image light 4, and green image light 6 are combined in the same optical path along optical axis 8 by color separator-combiner prism 61 to become image light 11a, 11b, 11c.

<Third Prism>

As illustrated in FIG. 4, third prism 137 has bottom surface 22 facing third DMD (51G), and first side surface 24 and second side surface 26 adjacent to bottom surface 22. Bottom surface 22 is disposed so as to be orthogonal to optical axis 8.

<First side surface>

First side surface 24 is disposed at an angle of not 90 degrees with respect to bottom surface 22. Specifically, first side surface 24 is disposed at an angle of @1 with respect to a perpendicular line of bottom surface 22. In a case where φ1 is a positive value that is not 0 degrees, φ1 is disposed at an obtuse angle with respect to bottom surface 22.

First side surface 24 is configured to reflect unnecessary light 16. For example, first side surface 24 may be mirror-processed so as to reflect unnecessary light 16. Alternatively, when incident angle θ1 at which unnecessary light 16 is incident on first side surface 24 is equal to or larger than critical angle θc, unnecessary light 16 can be totally reflected by first side surface 24.

Further, unnecessary light 16 reflected by first side surface 24 is totally reflected by bottom surface 22. The condition that unnecessary light 16 reflected by first side surface 24 is totally reflected by bottom surface 22 will be described below.

FIG. 5 is a schematic view illustrating an optical path of unnecessary light 16 in FIG. 4 in third prism 137. In FIG. 5, for convenience, only the angular relationship is extracted and described. For example, point C of optical path ABC is not a point at which the unnecessary light is incident on the bottom surface, but an intersection with optical axis 8 is set as point C. As a result, straight line AC can be aligned with optical axis 8. Point F is an intersection of perpendicular lines drawn from point B onto line AC parallel to optical axis 8. In optical path CD, point E is an intersection of perpendicular lines drawn from point D onto line AC parallel to optical axis 8.

On the basis of FIG. 5, in a case where the following Formulas 1 to 3 are satisfied for angle 2α formed with optical axis 8 of unnecessary light 16, incident angle θ1 of unnecessary light 16 to first side surface 24, incident angle θ2 of unnecessary light 16 to bottom surface 22, angle φ1 formed by first side surface 24 with the normal line of bottom surface 22, and critical angle θc of the sodium d-line (d1:589.6 nm, d2:589.0 nm) in third prism 137, unnecessary light 16 reflected by first side surface 24 is totally reflected by bottom surface 22.

$$φ 1 > 0 \qquad ( Formula 1 )$$

$$θ1 = 90 ° - 2 α - φ1 > θ c \qquad ( Formula 2 )$$

$$θ2 = 2 α + 2 φ1 > θ c \qquad ( Formula 3 )$$

### Second Side Surface

In second side surface 26, unnecessary light 16 may be transmitted and guided to the outside of the prism. In this case, incident angle θ3 of unnecessary light 16 on second side surface 26 is required to be equal to or smaller than critical angle θc as shown in the following Formula 4 based on angle φ2 formed by second side surface 26 and the normal line to bottom surface 22 in addition to the above angles.

θ3=90°−θ2−φ2≤θc (Formula4)

As a result, heat generation of prisms 134, 136, 137 and the light modulation elements 51B, 51R, and 51G can be suppressed. For example, the DMD incident energy equivalent to 30 kilo lumens (klm) is about 80 W to 90 W, but the intensity of unnecessary light 16 W is about 10 W, and heat generation can be reduced by about 5% to 10%.

Furthermore, absorption plate 28 that absorbs unnecessary light 16 may be provided on second side surface 26. As a result, it is possible to suppress the influence of unnecessary light 16 on a device or the like outside the prism.

Second side surface 26 may be a diffusion surface instead of a mirror surface.

In the above description, as illustrated in FIG. 4, the case where a part of image light 2 from first light modulation element 51B is transmitted through first dichroic surface 139 and becomes unnecessary light has been described as an example of unnecessary light 16, but the present invention is not limited to the above case. For example, as illustrated in FIG. 8, it can be seen that when a part of image light 4 from second light modulation element 51R is also reflected by first dichroic surface 139, the optical path becomes the same as that of the unnecessary light. Further, it can be seen that when a part of image light 6 from third light modulation element 51G is also reflected by first dichroic surface 139, the optical path becomes the same as that of the unnecessary light. That is, a part of image light 2, 4, and 6 from any of first light modulation element 51B, second light modulation element 51R, and third light modulation element 51G may be unnecessary light.

According to the configuration of the image generation unit of the first exemplary embodiment, unnecessary light 16 reflected by first side surface 24 of the third prism is totally reflected by bottom surface 22. As a result, it is possible to prevent unnecessary light 16 from hitting third light modulation element 51B, and to prevent the unnecessary light from being absorbed and generating heat.

<Projection Optical System>

Projection optical system 70 projects generated image light 11 onto a screen or the like to form an image.

<Controller>

Controller 80 controls light source unit 20, light guide optical system 50, image generation unit 60, and projection optical system 70 described above.

The present disclosure includes an appropriate combination of any exemplary embodiment and/or example among the various above-described exemplary embodiments and/or examples, and effects of each of the exemplary embodiments and/or examples can be achieved.

### INDUSTRIAL APPLICABILITY

According to the projection video display device using the image generation unit and the image generation unit of the present disclosure, even in a case where a part of the image light becomes unnecessary light and is transmitted through the prism, the unnecessary light does not reach the third light modulation element, and heat generation due to the unnecessary light can be suppressed.

### REFERENCE MARKS IN THE DRAWINGS

1: light from light source (illumination light)
1a, 1b, 1c: illumination light
2: blue image light
4: red image light
6: green image light
8: optical axis
9: OFF light
9a, 9b, 9c: OFF light
10: opening
11: image light
11a, 11b, 11c: image light
12: reflecting surface
14: light shielding plate
16: unnecessary light
20: light source unit
22: bottom surface
24: first side surface
26: second side surface
28: absorption plate
50: light guide optical system
51B: first light modulation element (first DMD)
51R: second light modulation element (second DMD)
51G: third light modulation element (third DMD)
60: image generation unit
61: color separator-combiner prism
70: projection optical system (projection unit)
100: projection type image display device
101a: first light source unit
101b: second light source unit
102: separating and combining mirror
103, 106, 108, 110, 112, 113, 116, 117, 123, 124, 126: lens
104, 109, 114, 125: mirror
105: diffuser plate
107: dichroic mirror
111: rod integrator
115: top hat diffusion element
118: phosphor wheel
119: phosphor
122: rotation shaft
128, 129, 134, 136, 137: prism
130, 131, 133, 135, 139, 144: surface

1. An image generation unit comprising:
three light modulation elements including a first light modulation element, a second light modulation element, and a third light modulation element that modulate light based on an image signal to generate image light; and
a color separator-combiner prism including a first prism, a second prism, and a third prism that are sequentially arranged along an optical axis and guide light to the first light modulation element, the second light modulation element, and the third light modulation element, respectively,
wherein the third prism has a bottom surface facing the third light modulation element and perpendicular to the optical axis, and a first side surface adjacent to the bottom surface,
a part of the image light from the first light modulation element is transmitted through a first dichroic surface between the first prism and the second prism as unnecessary light, is transmitted through the second prism, and is incident on the third prism,
the first side surface of the third prism is configured to reflect the unnecessary light incident on the third prism toward the bottom surface, and
the bottom surface of the third prism is configured to totally reflect the unnecessary light reflected by the first side surface.

2. The image generation unit according to claim 1, wherein the first side surface of the third prism forms an angle of not 90 degrees with respect to the bottom surface.

3. The image generation unit according to claim 2, wherein the first side surface forms an obtuse angle with respect to the bottom surface.

4. The image generation unit according to claim 1, wherein the first side surface is mirror-processed.

5. The image generation unit according to claim 1, wherein
following Formulas 1 to 3 are satisfied:
$$φ 1 > 0 \qquad ( Formula 1 )$$
$$θ1 = 90 ° - 2 α - φ1 > θ c \qquad ( Formula 2 )$$
$$θ2 = 2 α + 2 φ1 > θ c \qquad ( Formula 3 )$$
where 2α is an angle formed by the unnecessary light and the optical axis,
θ1 is an incident angle of the unnecessary light to the first side surface,
θ2 is an incident angle of the unnecessary light to the bottom surface,
φ1 is an angle formed by the first side surface and a normal line of the bottom surface, and
θc is a critical angle of a sodium d-line in the third prism.

6. The image generation unit according to claim 1, wherein
the third prism further includes a second side surface facing the first side surface, the bottom surface being interposed between the first side surface and the second side surface, and
the image generation unit further comprises an absorption plate that faces the second side surface and absorbs the unnecessary light totally reflected by the bottom surface.

7. A projection video display device comprising:
a light source unit configured to generate light;
the image generation unit according to claim 1;
a light guide optical system that guides light from the light source unit to the image generation unit; and
a projection optical system that projects the image light generated by the image generation unit.
